(19) United States
(12) Patent Application Publication
(10) Pub. No.: US 2007/0155901 A1
(43) Pub. Date: Jul. 5, 2007

(54) Acrylic shrinkable fiber

(76) Inventors: Kohei Kawamura, Hyogo (JP); Sohei Nishida, Hyogo (JP); Minoru Kuroda, Hyogo (JP); Toshiaki Ebisu, Hyogo (JP); Masahiko Mihoichi, Hyogo (JP)

Correspondence Address: BRINKS HOFER GILSON & LIONE, P.O. BOX 10395, CHICAGO, IL, 60610, US

(21) Appl. No.: 10/583,519

(22) PCT Filed: Dec. 24, 2004
(86) PCT No.: PCT/JP04/19769

§ 371 Date: Jun. 16, 2006

(30) Foreign Application Priority Data
Dec. 26, 2003 (JP) 2003-435464

(51) Int. Cl. C08F 8/00

(52) U.S. Cl. 525/191

(57) ABSTRACT

An acrylic shrinkable fiber that can be dyed at a low temperature, and has a high shrinkage percentage even after drying is provided. A dyeable acrylic shrinkable fiber comprising 50 to 99 parts by weight of a polymer (A) comprising 80 to 97 wt % of acrylonitrile, 0 to 2 wt % of a sulfonic acid group-containing monomer and 3 to 20 wt % of a monomer copolymerizable with the monomers; and 1 to 50 parts by weight of a polymer (B) comprising 0 to 89 wt % of acrylonitrile, 1 to 40 wt % of a sulfonic acid group-containing monomer and 10 to 99 wt % of a monomer copolymerizable with the monomers, wherein the polymers (A) and (B) are 100 parts by weight in total is provided.

### TECHNICAL FIELD

The present invention relates to an acrylic shrinkable fiber that can be dyed at a low temperature.

### BACKGROUND ART

Conventionally, acrylic fibers have texture like animal hair, and are used in artificial fur goods such as toys and clothes due to their characteristics. In particular, pile fabrics have a down hair part composed of a shrinkable fiber and a guard hair part composed of a non-shrinkable fiber in appearance in many cases, so as to provide the artificial fur goods with plush texture and natural appearance.

Since pile fabrics are required to have appearance characteristics, shrinkable fibers are also required to have various hues. However, shrinkable fibers have only limited kinds of hues produced by coloration in the spinning process.

There have been disclosed so far a highly shrinkable acrylic fiber comprising a polymer of 80 wt % of acrylonitrile, 0.5 to 5 wt % of a sulfonic acid group-containing monomer and 5 to 15 wt % of a vinyl monomer and obtained by drawing the polymer at a ratio of 4 to 10 in wet spinning, then causing the fiber to shrink at 30% or more during drying, and further dry heat drawing the fiber at a ratio of 1.2 to 2.0 (Japanese Patent Laid-open No. 4-119114); and a highly shrinkable acrylic fiber comprising a polymer of 90 to 95% of acrylonitrile, 0 to 0.5 wt % of a sulfonic acid-containing vinyl monomer and 10 to 4.5 wt % of other vinyl monomers and obtained by spin drawing the fiber at a ratio of 2 to 6, drying the fiber, then relaxing the fiber at 30% or more in pressurized steam, and dry heat drawing the fiber at a ratio of 1.6 to 2.2 (Japanese Patent Laid-open No. 2003-268623), for example. According to the knowledge of the present inventors, these shrinkable fibers shrink when dyed at 80° C. or more, and cannot sufficiently shrink to make steps(two-tone) appear in the tenter process in which an adhesive applied to the pile back surface during pile processing is dried and steps appear by the difference in shrinkage percentage. Furthermore, these fibers cannot be sufficiently dyed at less than 80° C. Thus, there are no conditions for the fibers to achieve dyeability and shrinkability after dyeing together.

There are also disclosed ultrafine acrylic fibers having a size of 0.01 to 0.5 dtex with improved dyeability at a low temperature, the fiber comprising a copolymer comprising 0.4 to 1.4 mol % of a sulfonic acid group-containing monomer such as sodium p-styrenesulfonate, p-styrenesulfonic acid, sodium 2-acrylamido-2-methylpropanesulfonate, 2-acrylamido-2-methylpropanesulfonic acid, sodium methallyloxybenzenesulfonate and methallyloxybenzenesulfonaic acid (Japanese Patent Laid-open Nos. 8-325833, 8-325834 and 8-325835). However, it is difficult to obtain sufficient low-temperature dyeability by these methods when the size of fibers is large.

These problems are still to be solved, and dyeable acrylic shrinkable fibers having a high shrinkage percentage even after dyeing cannot still be provided.

### DISCLOSURE OF THE INVENTION

An object of the present invention is to solve the above problems of the prior art and to provide an acrylic shrinkable fiber that can be dyed at a low temperature and have a high shrinking percentage even after dyeing.

As a result of extensive studies to solve the above problems, the present inventors have found that an acrylic shrinkable fiber that can be dyed at a low temperature and have a high shrinkage percentage after dyeing can be obtained by spinning a mixed solution of two acrylic polymers.

Specifically, the present invention relates to a dyeable acrylic shrinkable fiber comprising 50 to 99 parts by weight of a polymer (A) comprising 80 to 97 wt % of acrylonitrile, 0 to 2 wt % of a sulfonic acid group-containing monomer and 3 to 20 wt % of a monomer copolymerizable with the monomers; and 1 to 50 parts by weight of a polymer (B) comprising 0 to 89 wt % of acrylonitrile, 1 to 40 wt % of a sulfonic acid group-containing monomer and 10 to 99 wt % of a monomer copolymerizable with the monomers, wherein the polymers (A) and (B) are 100 parts by weight in total.

The total content of the sulfonic acid group-containing monomers in the polymers (A) and (B) is preferably 0.1 to 10 wt % based on the total monomer content in the polymers (A) and (B).

The present invention also relates to an acrylic shrinkable fiber comprising a polymer comprising 80 to 97 wt % of acrylonitrile, and having a relative saturation value of 0.2 or more when dyed at less than 80° C.

The acrylic shrinkable fiber preferably has a shrinkage percentage of 20% or more when treated with dry heat at 130° C. for five minutes after dyed at less than 80° C.

### BEST MODE FOR CARRYING OUT THE INVENTION

The present invention provides a dyeable acrylic shrinkable fiber comprising 50 to 99 parts by weight of a polymer (A) comprising 80 to 97 wt % of acrylonitrile, 0 to 2 wt % of a sulfonic acid group-containing monomer and 3 to 20 wt % of a monomer copolymerizable with the monomers; and 1 to 50 parts by weight of a polymer (B) comprising 0 to 89 wt % of acrylonitrile, 1 to 40 wt % of a sulfonic acid group-containing monomer and 10 to 99 wt % of a monomer copolymerizable with the monomers, wherein the polymers (A) and (B) are 100 parts by weight in total.

In the polymer (A), the acrylonitrile content is 80 to 97 wt %, and more preferably 85 to 95 wt %. If the acrylonitrile content is less than 80 wt %, the resulting fiber has too low heat resistance. If more than 97 wt %, the fiber has too high heat resistance, and cannot have sufficient dyeability and shrinkage percentage.

The sulfonic acid group-containing monomer in the polymer (A) is preferably allylsulfonic acid, methallylsulfonic acid, styrenesulfonic acid, vinylsulfonic acid, isoprenesulfonic acid, 2-acrylamido-2-methylpropanesulfonic acid, or a metal salt or amine salt thereof. These may be used singly or in a mixture of two or more. The content of the sulfonic acid-containing monomer in the polymer (A) is preferably 0 to 2 wt % and more preferably 0.5 to 1.5 wt % in order to avoid formation of voids in the resulting fiber.

Preferable examples of the other copolymerizable monomer in the polymer (A) include acrylic acid, methacrylic acid and their lower alkyl esters, N- or N,N-alkyl substituted aminoalkyl esters or glycidyl esters; acrylamide, methacrylamide and their N- or N,N-alkyl substituted products; anionic vinyl monomers such as carboxyl group-containing vinyl monomers typified by acrylic acid, methacrylic acid and itaconic acid and their sodium, potassium or ammonium salts; cationic vinyl monomers typified by quaternary aminoalkyl esters of acrylic acid or methacrylic acid; vinyl group-containing lower alkyl ethers; vinyl group-containing lower carboxylic acid esters typified by vinyl acetate; vinyl halides and vinylidene halides typified by vinyl chloride, vinylidene chloride, vinyl bromide and vinylidene bromide; and styrene. These monomers may be used singly or in a mixture of two or more. The content of the other copolymerizable monomer in the polymer (A) is 3 to 20 wt %, and more preferably 5 to 15 wt %. If the content is more than 20 wt %, the resulting fiber has too low heat resistance. If less than 3 wt % or more, the fiber cannot have a sufficient shrinkage percentage.

The acrylonitrile content in the polymer (B) is 0 to 89 wt %, and more preferably 5 to 70 wt %. If the content is more than 89 wt %, the fiber has too high heat resistance, and thus cannot have sufficient dyeability and shrinkage percentage.

As the sulfonic acid group-containing monomer in the polymer (B), a compound described above as the sulfonic acid group-containing monomer in the polymer (A) is used. The content of the sulfonic acid-containing monomer in the polymer (B) is 1 to 40 wt %, and more preferably 2 to 30 wt %. If the content is more than 40 wt %, voids or agglutination are formed in the fiber, and a decrease in strength and elution during dyeing occur, undesirably. If less than 1 wt %, the fiber cannot have sufficient dyeability.

As the other copolymerizable monomer in the polymer (B), a compound described above as the other copolymerizable monomer in the polymer (A) is used. The content of the other copolymerizable monomer in the polymer (B) is 10 to 99 wt %, and more preferably 20 to 80 wt %. If the content is less than 10 wt %, the fiber has too high heat resistance, and thus cannot have sufficient dyeability.

The acrylic shrinkable fiber of the present invention comprises 50 to 99 parts by weight of the polymer (A) and 1 to 50 parts by weight of the polymer (B), and preferably comprises 70 to 95 parts by weight of the polymer (A) and 5 to 30 parts by weight of the polymer (B). However, the polymers (A) and (B) are added so that the total amount is 100 parts by weight. If the polymer (B) is less than 1 part by weight, the fiber cannot have sufficient dyeability. If more than 50 parts by weight, voids or agglutination are formed in the fiber, and the fiber has decreased strength, undesirably.

In the acrylic shrinkable fiber of the present invention, the total content of the sulfonic acid group-containing monomers in the polymers (A) and (B) is preferably 0.1 to 10 wt %, and more preferably 0.2 to 5 wt % based on the total monomer content in the polymers (A) and (B). If the total content is less than 0.1 wt %, the fiber cannot have sufficient dyeability. If more than 10 wt %, voids or agglutination are formed in the fiber, and the fiber has decreased strength, undesirably.

The polymers (A) and (B) in the present invention can be obtained by a conventional vinyl polymerization method such as emulsion polymerization, suspension polymerization or solution polymerization, using a known compound, for example, a peroxide compound, an azo compound, or various redox compounds as an initiator.

The polymers (A) and (B) can be dissolved in an organic solvent, for example, acetonitrile, dimethylformamide, dimethylacetamide or dimethyl sulfoxide, or in an inorganic solvent, for example, zinc chloride, nitric acid or rhodan salt to prepare a spinning solution. An inorganic and/or organic pigment such as titanium oxide or a coloring pigment, a stabilizer effective for anti-corrosion, coloring spinning or weather resistance, or the like can be used for the spinning solution, insofar as spinning can be carried out without problems. The acrylic shrinkable fiber of the present invention thus obtained can be dyed at a low temperature. The dyeing temperature is preferably 50 to 90° C., and more preferably 60 to 80° C. If the dyeing temperature is less than 50° C., the fiber cannot be sufficiently dyed. If more than 90° C., the fiber shrinks when dyed, and thus cannot have a sufficient shrinkage percentage by dry heat treatment after dyeing.

The relative saturation value in the present invention is an index of dyeability of the fiber. The fiber is dyed with any supersaturation concentration of Malachite Green in a bath ratio of 1:200 (=fiber weight:dye liquor weight) at any temperature for 60 minutes to determine the saturation dyeing amount. The relative saturation value is determined by the saturation dyeing amount. The saturation dyeing amount and the relative saturation value were determined by the following formulas (1) and (2).
(Saturation concentration of dye)=((Ao−A)/Ao)×X) (1)

A: Absorbance of remaining dye bath after dyeing (wavelength: 618 nm)

Ao: Absorbance of dye bath before dyeing (wavelength: 618 nm)

X: Supersaturation concentration of Malachite Green (% omf)
(Relative saturation value)=(Saturation dyeing amount)×400/463 (2)

Since the acrylic shrinkable fiber of the present invention can be lightly dyed at a relative saturation value of 0.2 or more, the relative saturation value in dyeing at less than 80° C. is preferably 0.2 or more. Further, since the fiber can be dyed to light to dark colors, or even black at a relative saturation value of 0.8 or more, the relative saturation value is more preferably 0.8 or more.

The fiber is preferably dyed with a cationic dye in terms of dyeing fastness, color appearance and cost efficiency. A conventionally known cationic dye can be used without specific limitations. Examples include Maxilon series manufactured by Ciba Specialty Chemicals Inc. and Cathilon series manufactured by Hodogaya Chemical Co., Ltd. There are no specific limitations to the amount of the cationic dye used. However, at a dyeing temperature within the above range, the amount is preferably 0.1 to 3.0 parts by weight based on 100 parts by weight of the acrylic shrinkable fiber, in terms of practical use as well. It is not particularly necessary to use a dyeing promoter, but a conventionally known dyeing promoter may be used according to examples in the prior art. A conventional dyeing machine can also be used.

The acrylic shrinkable fiber of the present invention after the dyeing process is treated with dry heat in the tenter process in pile processing to shrink. The fiber shrinkage percentage herein is determined by the following formula (3).
Shrinkage percentage after dyeing (%)=((Ldo−Ld)/Ldo)×100 (3)

Ld: Fiber length after dry heat treatment

Ldo: Fiber length after dyeing (before dry heat treatment)

Since the tenter process is carried out with dry heat at 130° C., the shrinkage percentage is measured after dry heat treatment with a holding oven at 130° C. for five minutes.

The shrinkage percentage of the acrylic shrinkable fiber of the present invention treated with dry heat at 130° C. for five minutes is preferably 20% or more, and more preferably 25% or more. If the shrinkage percentage is less than 20%, the fiber processed into a pile fabric has a small step from the non-shrinking raw fiber, and thus the step cannot be distinguishable. Accordingly, a pile fabric having natural or well-designed appearance characteristics cannot be obtained.

To obtain acrylic shrinkable fiber of the present invention, the spinning solution is spun through a nozzle by a conventional wet or dry spinning method, drawn, and dried. The spun fiber may be further drawn or treated with heat as necessary. Further, the resulting fiber can be drawn at a ratio of 1.3 to 4.0 at 70 to 140° C. to obtain a shrinkable fiber.

The acrylic shrinkable fiber of the present invention can be dyed at a low temperature, and has a high shrinkage percentage even after drying. Accordingly, various new goods with a wide variety of hues such as clothes, toys (such as stuffed toys) and interior goods using the fiber can be planned.

### EXAMPLES

The present invention will be specifically described below by way of examples. However, the present invention is not limited thereto. “Part(s)” and “%” in the examples refer to part(s) by weight and wt %, respectively, unless otherwise indicated.

### Production Example 1

A pressure polymerization reactor having an internal volume of 20 L was charged with 233 parts of dimethylformamide (DMF), 90 parts of acrylonitrile (hereinafter referred to as AN), 9.5 parts of methyl acrylate (hereinafter referred to as MA) and 0.5 part of sodium 2-acrylamido-2-methylpropanesulfonate (hereinafter referred to as SAM), and the internal atmosphere was replaced with nitrogen. The polymerization reactor was adjusted to a temperature of 65° C., and charged with 0.5 part of 2,2-azobis(2,4-dimethylvaleronitrile) (AIVN) as an initiator to initiate polymerization. The components were polymerized for two hours while adding 1.0 part of AIVN during the polymerization. Then, the components were heated to 70° C. and polymerized for 10 hours to obtain a 30% solution of a polymer (A) (AN/MA/SAM=90/9.5/0.5 (weight ratio)). Next, a pressure polymerization reactor having an internal volume of 5 L was charged with 233 pars of DMF, 40 parts of AN, 50 parts of MA and 10 parts of SAM, and the internal atmosphere was replaced with nitrogen. The polymerization reactor was adjusted to a temperature of 65° C., and charged with 0.5 part of AIVN as an initiator to initiate polymerization. The components were polymerized for two hours while adding 1.0 part of AIVN during the polymerization. Then, the components were heated to 70° C. and polymerized for two hours to obtain a 30% solution of a polymer (B) (AN/MA/SAM=40/50/10).

The polymer (A) was mixed with the polymer (B) at a mixing ratio (A:B) of 90:10 to prepare a spinning solution. The spinning solution was extruded through a spinneret with 8,500 holes having a diameter of 0.08 mm to a 50% aqueous DMF solution at 20° C., drawn at a ratio of 2.1 through five baths for washing and drawing in which solvent concentrations sequentially decreased, and then washed with water at 70° C. Thereafter, the resulting fiber was applied with finishing oil, dried in an atmosphere at 120° C., and drawn at a ratio of 1.7 with a heat roller in a dry heat atmosphere of 120° C. to obtain a drawn yarn (shrinkable fiber) with a size of 4.4 dtex.

### Production Examples 2 to 18

A spinning solution having a composition of a polymer (A), a composition of a polymer (B) and a mixing ratio of the polymer (A) to the polymer (B) shown in Table 1 was prepared and spun in the same manner as in Example 1 to obtain a drawn yarn.

TABLE 1

| | | | | | | | Mixing ratio | | |
|---|---|---|---|---|---|---|---|---|---|
| | Composition of | | | Composition of | | | of polymer (A) | | SAM ratio |
| | polymer (A) | | | polymer (B) | | | to polymer (B) | | in total |
| | (weight ratio) | | | (weight ratio) | | | (weight ratio) | | polymers |
| Production Example | AN | MA | SAM | AN | MA | SAM | (A) | (B) | (wt %) |
| Production Example 1 | 90 | 9.5 | 0.5 | 40 | 50 | 10 | 90 | 10 | 1.45 |
| Production Example 2 | 90 | 9.5 | 0.5 | 40 | 59 | 1 | 60 | 40 | 0.70 |
| Production Example 3 | 90 | 9.5 | 0.5 | 40 | 58 | 2 | 70 | 30 | 0.95 |
| Production Example 4 | 90 | 9.5 | 0.5 | 40 | 30 | 30 | 96 | 4 | 1.68 |
| Production Example 5 | 90 | 9.5 | 0.5 | 40 | 30 | 30 | 98 | 2 | 1.09 |
| Production Example 6 | 90 | 9.5 | 0.5 | 40 | 55 | 5 | 80 | 20 | 1.40 |
| Production Example 7 | 90 | 9.5 | 0.5 | 0 | 90 | 10 | 90 | 10 | 1.45 |
| Production Example 8 | 90 | 9.5 | 0.5 | 80 | 10 | 10 | 90 | 10 | 1.45 |
| Production Example 9 | 90 | 9.5 | 0.5 | — | — | — | 100 | 0 | 0.50 |
| Production Example 10 | 90 | 9.5 | 0.5 | 40 | 60 | — | 50 | 50 | 0.50 |
| Production Example 11 | 90 | 10 | — | 40 | 50 | 10 | 90 | 10 | 1.00 |
| Production Example 12 | 90 | 10 | — | — | — | — | 100 | 0 | 0.00 |
| Production Example 13 | 90 | 9 | 1 | 40 | 50 | 10 | 90 | 10 | 1.90 |
| production Example 14 | 90 | 9 | 1 | — | — | — | 100 | 0 | 1.00 |
| production Example 15 | 80 | 19.5 | 0.5 | 40 | 50 | 10 | 90 | 10 | 1.45 |
| production Example 16 | 80 | 19.5 | 0.5 | — | — | — | 100 | 0 | 0.50 |
| production Example 17 | 95 | 4.5 | 0.5 | 40 | 50 | 10 | 90 | 10 | 1.45 |
| production Example 18 | 95 | 4.5 | 0.5 | — | — | — | 100 | 0 | 0.50 |

### Examples 1 to 12 and Comparative Examples 1 to 14

0.05 g/L of acetic acid and 0.02 g/L of sodium acetate were added to 200 cc of 2.5% omf of a Malachite Green dye bath, and the bath was adjusted to pH 3 to 4. 1 g each of the shrinkable fibers obtained in Production Examples 1 to 18 was dyed with the dye bath at a temperature described in Table 2 for 60 minutes. The relative saturation values and the shrinkage percentages after dyeing were measured at that time. The results are shown in Table 2.

TABLE 2

| | | | | |
|---|---|---|---|---|
| Example 1 | Production Example 1 | 70 | 0.8 | 23 |
| 2 | Production Example 2 | 70 | 0.2 | 21 |
| 3 | Production Example 3 | 70 | 1.0 | 20 |
| 4 | Production Example 4 | 70 | 0.6 | 23 |
| 5 | Production Example 5 | 70 | 1.2 | 23 |
| 6 | Production Example 6 | 70 | 0.7 | 23 |
| 7 | Production Example 7 | 70 | 0.9 | 23 |
| 8 | Production Example 8 | 70 | 0.7 | 22 |
| 9 | Production Example 11 | 70 | 0.7 | 21 |
| 10 | Production Example 13 | 70 | 1.0 | 21 |
| 11 | Production Example 15 | 70 | 0.9 | 22 |
| 12 | Production Example 17 | 70 | 0.8 | 22 |
| Comparative | Production Example 9 | 70 | 0.0 | 25 |
| Example 1 | | | | |
| 2 | Production Example 9 | 80 | 0.2 | 10 |
| 3 | Production Example 9 | 90 | 0.4 | 1 |
| 4 | Production Example 10 | 60 | 0.0 | 15 |
| 5 | Production Example 10 | 70 | 0.1 | 12 |
| 6 | Production Example 10 | 80 | 0.3 | 5 |
| 7 | Production Example 12 | 70 | 0.0 | 25 |
| 8 | Production Example 12 | 80 | 0.1 | 10 |
| 9 | Production Example 14 | 70 | 0.0 | 24 |
| 10 | Production Example 14 | 80 | 0.4 | 10 |
| 11 | Production Example 16 | 70 | 0.0 | 22 |
| 12 | Production Example 16 | 80 | 0.2 | 10 |
| 13 | Production Example 18 | 70 | 0.0 | 22 |
| 14 | Production Example 18 | 80 | 0.1 | 10 |

Any of the fibers of Examples 1 to 12 exhibited sufficient dyeability and shrinkage percentage after dyeing. On the other hand, it was difficult to achieve dyeability and shrink properties after dyeing together in the fibers of Comparative Examples 1 to 14. In Comparative Examples 7 to 14, the tendency in the dyeability and shrinkage percentage was almost not changed even when the SAM or AN ratio in the polymer (A) was changed.

### INDUSTRIAL APPLICABILITY

The acrylic shrinkable fiber of the present invention can be dyed at a low temperature, and has a high shrinkage percentage even after drying. Accordingly, various new goods such as clothes, toys (such as stuffed toys) and interior goods using the fiber can be planned.

1. A dyeable acrylic shrinkable fiber comprising 50 to 99 parts by weight of a polymer (A) comprising 80 to 97 wt % of acrylonitrile, 0 to 2 wt % of a sulfonic acid group-containing monomer and 3 to 20 wt % of a monomer copolymerizable with the monomers; and 1 to 50 parts by weight of a polymer (B) comprising 0 to 89 wt % of acrylonitrile, 1 to 40 wt % of a sulfonic acid group-containing monomer and 10 to 99 wt % of a monomer copolymerizable with the monomers, wherein the polymers (A) and (B) are 100 parts by weight in total.

2. The acrylic shrinkable fiber according to claim 1, wherein the total content of the sulfonic acid group-containing monomers in the polymers (A) and (B) is 0.1 to 10 wt % based on the total monomer content in the polymers (A) and (B).

3. An acrylic shrinkable fiber comprising a polymer comprising 80 to 97 wt % of acrylonitrile, and having a relative saturation value of 0.2 or more when dyed at less than 80° C.

4. The acrylic shrinkable fiber according to claim 1, having a shrinkage percentage of 20% or more when treated with dry heat at 130° C. for five minutes after dyed at less than 80° C.

5. The acrylic shrinkable fiber according to claim 2 having a shrinkage percentage of 20% or more when treated with dry heat at 130° C. for five minutes after dyed at less than 80° C.

6. The acrylic shrinkable fiber according to claim 3 having a shrinkage percentage of 20% or more when treated with dry heat at 130° C. for five minutes after dyed at less than 80° C.
